(19) United States
(12) Patent Application Publication
(10) Pub. No.: US 2026/0011498 A1
(43) Pub. Date: Jan. 8, 2026

(54) CAPACITOR AND METHOD OF MANUFACTURING THE SAME

(71) Applicant: TAIYO YUDEN CO., LTD., Tokyo (JP)

(72) Inventor: Ayumi MATSUOKA, Tokyo (JP)

(21) Appl. No.: 19/327,877

(22) Filed: Sep. 12, 2025

Related U.S. Application Data
(63) Continuation of application No. PCT/JP2024/003765, filed on Feb. 5, 2024.

(30) Foreign Application Priority Data
Mar. 16, 2023 (JP) 2023-042020

(51) Int. Cl. H01G 4/12; H01G 4/008; H01G 4/232; H01G 4/248; H01G 4/30

(52) U.S. Cl. CPC H01G 4/1227; H01G 4/008; H01G 4/232; H01G 4/248; H01G 4/30

(57) ABSTRACT

One object is to inhibit the reduction of insulation resistance in the dielectric layer of a capacitor that includes an intermediate layer containing Fe. A capacitor according to one aspect of the disclosure includes a body, a first external electrode, and a second external electrode. The body includes a first internal electrode layer, a second internal electrode layer, a dielectric layer, and a first intermediate layer. The dielectric layer is disposed between the first internal electrode layer and the second internal electrode layer. The dielectric layer contains Fe²⁺ and Fe³⁺. The first intermediate layer is disposed between the first internal electrode layer and the dielectric layer, and contains Fe. In the dielectric layer, an Fe²⁺ content ratio, which represents an atomic ratio of Fe²⁺ to a total of Fe²⁺ and Fe³⁺, may be from 0.4 to 0.85.

### CROSS-REFERENCE TO RELATED APPLICATIONS

This is a continuation application of a PCT application No. PCT/JP2024/3765 filed on Feb. 5, 2024, which is based on and claims the benefit of priority from Japanese patent Application serial No. 2023-042020 (filed on Mar. 16, 2023). The contents of the PCT and Japanese applications are hereby incorporated by reference in their entirety.

### TECHNICAL FIELD

The disclosure herein relates mainly to a capacitor and a method of manufacturing the capacitor. The disclosure herein also relates to a circuit module with the capacitor and an electronic device with the circuit module.

### BACKGROUND

As the electronic devices are downsized, there is a need to increase a capacitance generated by capacitors installed in electronic devices without increasing the size of the capacitors. Capacitors including thinner dielectric layers and internal electrode layers can have a larger capacitance without an increase in the size of the capacitors.

However, thinner dielectric layers may reduce the insulation reliability of the capacitors. For this reason, it has been proposed to provide an intermediate layer containing trace amounts of metal elements between the dielectric layer and the internal electrode layer, and increase the electrical barrier between the dielectric layer and the internal electrode layer with this intermediate layer, so as to improve the insulation reliability of the capacitor. For example, Japanese Patent Application Publication No. 2003-7562 (“the '562 Publication”) describes a capacitor in which an intermediate layer containing a metal element such as Au is provided between the dielectric layer and the internal electrode layer.

In addition, Japanese Patent Application Publication No. 2017-5021 (“the '021 Publication”) discloses that a metal element is added to the internal electrode layer, and this added metal element is present at the interface between the internal electrode layer and the dielectric layer at a higher proportion than in other regions, thereby changing the electrical barrier (Schottky barrier) at this interface.

The '562 Publication lists Au, Pt, Pd, Ag, and Cu, and the '021 Publication lists Fe, V, Y, and Cu, as additive metal elements for increasing the electrical barrier between the dielectric layer and the internal electrode layer.

The inventor of the present application focused on Fe as an additive metal element for increasing the electrical barrier between the dielectric layer and the internal electrode layer, because Fe can promote sintering of the dielectric layer when diffused into the dielectric layer, and Fe is inexpensive and readily available.

However, when an intermediate layer containing Fe is formed between the dielectric layer and the internal electrode layer, excessive Fe tends to diffuse into the dielectric layer. There is an issue that Fe contained in the dielectric layer decreases the insulation resistance of the dielectric layer.

With a reduced amount of Fe added to the internal electrode layer, the amount of Fe diffused into the dielectric layer can be reduced. Also, with a reduced amount of Fe added to the dielectric layer, the amount of Fe that remains in the dielectric layer can be reduced. Therefore, with reduced amounts of Fe added to the dielectric layer and the internal electrode layer, the decrease in insulation resistance in the dielectric layer can be inhibited. However, there is an issue that if the amount of Fe added is reduced, an intermediate layer is not sufficiently formed between the dielectric layer and the internal electrode layer, so that the electrical barrier between the dielectric layer and the internal electrode layer cannot be increased, and as a result, the insulation reliability of the capacitor is reduced.

### SUMMARY

It is an object of the present disclosure to solve or alleviate at least part of the drawback mentioned above. One of the more particular objects of the present disclosure is to inhibit the reduction of insulation resistance in the dielectric layer of a capacitor that includes an intermediate layer containing Fe. The various inventions disclosed herein may be collectively referred to as “the invention”.

Other objects of the disclosure will be made apparent through the entire description in the specification. The invention disclosed herein may also address drawbacks other than that grasped from the above description. When an advantageous effect of an embodiment is described herein, the advantageous effect suggests an object of the invention corresponding to the embodiment.

A capacitor according to one aspect of the disclosure includes a body, a first external electrode, and a second external electrode. In one aspect, the body includes a first internal electrode layer, a second internal electrode layer, a dielectric layer, and a first intermediate layer. The dielectric layer is disposed between the first internal electrode layer and the second internal electrode layer. The dielectric layer contain Fe²⁺ and Fe³⁺. The first intermediate layer is disposed between the first internal electrode layer and the dielectric layer, and contains Fe. The first external electrode is provided on the body so as to be electrically connected to the first internal electrode layer. The second external electrode is provided on the body so as to be electrically connected to the second internal electrode layer. In the dielectric layer, an Fe²⁺ content ratio, which represents an atomic ratio of Fe²⁺ to a total of Fe²⁺ and Fe³⁺, may be from 0.4 to 0.85.

### Advantageous Effects

According to one embodiment of the disclosure, the reduction of insulation resistance in the dielectric layer can be inhibited in a capacitor that includes an intermediate layer containing Fe.

### BRIEF DESCRIPTION OF THE DRAWINGS

FIG. 1 is a perspective view schematically showing a capacitor according to one embodiment of the disclosure.

FIG. 2 is a sectional view schematically showing a section of the capacitor of FIG. 1 cut along the line I-I.

FIG. 3 is an enlarged sectional view showing a part of the section shown in FIG. 2 on an enlarged scale.

FIG. 4 is an enlarged sectional view showing a part of the section shown in FIG. 2 on an enlarged scale.

FIG. 5 is a flowchart showing a flow of a production method of a capacitor according to one embodiment of the disclosure.

FIG. 6 is a flowchart showing a flow of a production method of a capacitor according to another embodiment of the disclosure.

### DESCRIPTION OF THE PREFERRED EMBODIMENTS

Various embodiments of the disclosure will be described hereinafter with reference to the appended drawings. Throughout the drawings, the same components are denoted by the same or like reference numerals. For convenience of explanation, the drawings are not necessarily drawn to scale. The following embodiments of the disclosure do not limit the scope of the claims. The elements included in the following embodiments are not necessarily essential to solve the problem addressed by the invention.

For convenience of explanation, each of the drawings may show the L axis, the W axis, and the T axis orthogonal to one another. In this specification, the dimensions, arrangement, shape, and other features of each component of a capacitor 1 may be described with reference to the L, W, and T axes.

### (1) Capacitor 1

### (1-1) Basic Structure of Capacitor 1

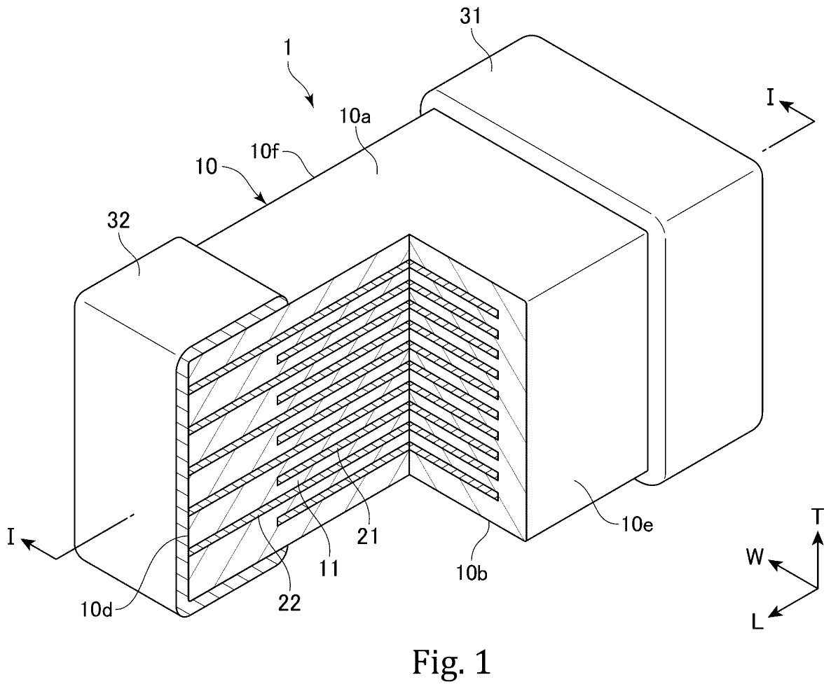

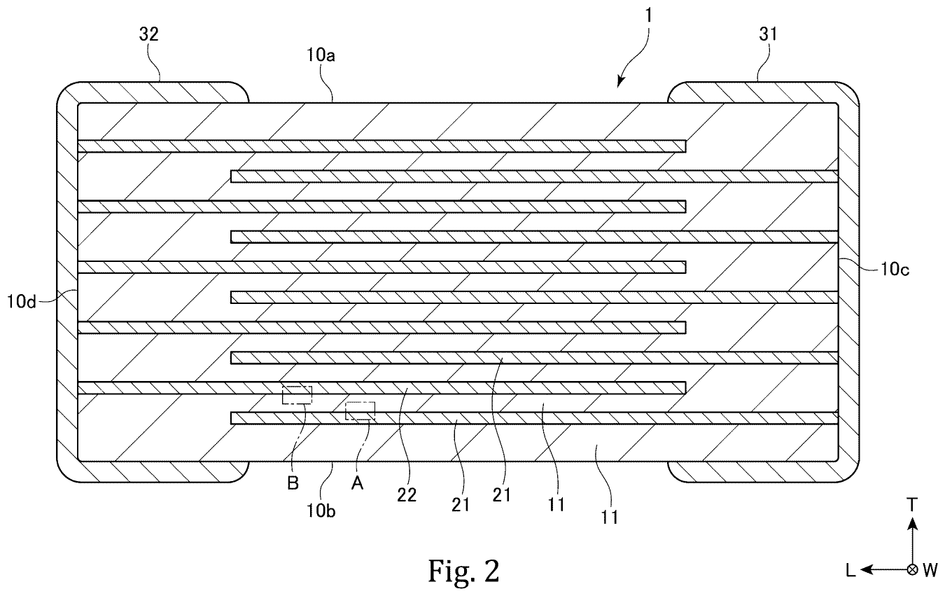

Referring to FIGS. 1 and 2, a description will now be given of the basic structure of a capacitor 1 according to a first embodiment. FIG. 1 is a perspective view showing the capacitor 1 according to the first embodiment FIG. 2 is a sectional view schematically showing a section of the capacitor 1 cut along the line I-I.

The capacitor 1 includes a body 10 having an insulating property, and a first external electrode 31 and a second external electrode 32 provided on the body 10. The first external electrode 31 is spaced apart from the second external electrode 32. In the example shown, the first external electrode 31 is spaced apart from the second external electrode 32 in the L-axis direction.

The body 10 has a top surface 10a, a bottom surface 10b, a first end surface 10c, a second end surface 10d, a first side surface 10e, and a second side surface 10f. The outer surface of the body 10 is defined by the top surface 10a, the bottom surface 10b, the first end surface 10c, the second end surface 10d, the first side surface 10e, and the second side surface 10f.

The top surface 10a and the bottom surface 10b form the opposite ends of the body 10 in the height direction (T-axis direction). In other words, the top surface 10a and the bottom surface 10b are opposed to each other in the T-axis direction. The first end surface 10c and the second end surface 10d form the opposite ends of the body 10 in the length direction (L-axis direction). In other words, the first end surface 10c and the second end surface 10d are opposed to each other in the L-axis direction. The first side surface 10e and the second side surface 10f form the opposite ends of the body 10 in the width direction (W-axis direction). In other words, the first side surface 10e and the second side surface 10f are opposed to each other in the W-axis direction. The top surface 10a and the bottom surface 10b are separated from each other by a distance equal to the height of the body 10, the first end surface 10c and the second end surface 10d are separated from each other by a distance equal to the length of the body 10, and the first side surface 10e and the second side surface 10f are separated from each other by a distance equal to the width of the body 10.

The body 10 includes a plurality of dielectric layers 11, a plurality of first internal electrode layers 21, and a plurality of second internal electrode layers 22. A dielectric layer 11 is present between a first internal electrode layer 21 and a second internal electrode layer 22 adjacent to the first internal electrode layer 21. When voltage is applied between the first and second external electrodes 31 and 32, a capacitance is generated between the first internal electrode layer 21 and the second internal electrode layers 22 adjacent to the first internal electrode layer 21.

As will be described later, a first intermediate layer 41 containing Fe is located between the dielectric layer 11 and the first internal electrode layer 21, and a second intermediate layer 42 containing Fe is located between the dielectric layer 11 and the second internal electrode layer 22, but FIGS. 1 and 2 do not show the first intermediate layer 41 and the second intermediate layer 42.

The body 10 is composed of the dielectric layers 11, the first internal electrode layers 21, and the second internal electrode layers 22 stacked together along the lamination direction. In the illustrated embodiment, the dielectric layers 11, the first internal electrode layers 21, and the second internal electrode layers 22 are stacked together along the T-axis direction. The lamination direction may be along the T axis, as shown in the drawings, or may be along the L or W axis. The dielectric layers 11 located at the opposite ends in the lamination direction may be referred to as cover layers.

Each of the first internal electrode layers 21 has one end led toward the outside of the body 10. The first internal electrode layer 21 is connected to the first external electrode 31 provided on the surface of the body 10. Each of the second internal electrode layers 22 has one end led toward the outside of the body 10. The second internal electrode layer 22 is connected to the second external electrode 32 provided on the surface of the body 10. In the embodiment shown in FIG. 2, the first internal electrode layer 21 is led from one end in the L-axis direction toward the outside of the body 10. The first internal electrode layer 21 is connected to the first external electrode 31 at one end of the body 10 in the L-axis direction. The second internal electrode layer 22 is led from the other end in the L-axis direction toward the outside of the body 10. The second internal electrode layer 22 is connected to the second external electrode 32 at the other end of the body 10 in the L-axis direction. In the example shown in FIG. 2, the first and second internal electrode layers 21 and 22 are respectively led out to the first and second end surfaces 10c and 10d, which are opposed to each other, but the first and second internal electrode layers 21 and 22 can be led out through various surfaces of the body 10 in accordance with the locations and the shapes of the first and second external electrodes 31 and 32. For example, if both the first and second external electrodes 31 and 32 are located on the bottom surface 10b, both the first and second internal electrode layers 21 and 22 are led out through the bottom surface. The first and second external electrodes 31 and 32 may be located on any of the surfaces of the body 10 as long as they are separated from each other.

The capacitor 1 may be mounted on an electronic circuit board. The electronic circuit board having the capacitor 1 mounted thereon may be referred to as a circuit module. The circuit module may be installed in various electronic devices. The electronic devices in which the circuit module can be installed include smartphones, tablets, game consoles, electrical components of automobiles, servers, and various other electronic devices.

In one aspect, the capacitor 1 may be configured to have a rectangular parallelepiped shape. The term “rectangular parallelepiped” or “rectangular parallelepiped shape” used herein is not intended to mean solely “rectangular parallelepiped” in a mathematically strict sense. As described below, the corners and/or edges of the body 10 may be rounded. The dimensions and the shape of the body 10 are not limited to those specified herein.

In one aspect, the capacitor 1 has a dimension in the L-axis direction (length) of 0.2 mm to 2.5 mm, a dimension in the W-axis direction (width) of 0.1 mm to 3.5 mm, and a dimension in the T-axis direction (height) of 0.1 mm to 3.0 mm. In one aspect, the length of the capacitor 1 may be larger than the width thereof. In one aspect, the height of the capacitor 1 may be larger than the width thereof. In one aspect, the width of the capacitor 1 may be larger than the length thereof.

### (1-2) Dielectric Layers 11

The dielectric layers 11 contain as their main component an oxide represented by a chemical formula ABO₃. The oxide may have a perovskite structure. A component that is at least 50 wt % of the dielectric layers 11 with reference to the total mass of the dielectric layers 11 can be regarded as the main component of the dielectric layers 11. When the dielectric layers 11 contain 50 wt % or more of the oxide represented by the chemical formula ABO₃, the dielectric layers 11 can be considered to contain the oxide represented by the chemical formula ABO₃ as their main component. The dielectric layers 11 preferably contain at least 60 wt %, 70 wt %, 80 wt %, or 90 wt % of the oxide represented by the chemical formula ABO₃.

In the chemical formula ABO₃, “A” is at least one element selected from the group consisting of Ba (barium), Sr (strontium), Ca (calcium), and Mg (magnesium). In the chemical formula ABO₃, “B” is at least one element selected from the group consisting of Ti (titanium), Zr (zirconium), and Hf (hafnium). When the oxide represented by the chemical formula ABO₃ has a perovskite structure, the elements “A” and “B” are located at the A site and the B site of the perovskite structure, respectively. Examples of the oxide contained in the dielectric layers 11 as their main component include BaTiO₃ (barium titanate), CaZrO₃ (calcium zirconate), CaTiO₃ (calcium titanate), SrTiO₃ (strontium titanate), and MgTiO₃ (magnesium titanate). The oxide contained in the dielectric layers 11 as the main component may be an oxide represented by the chemical formula Ba_{1-x-y}CaₓSr_{y}Ti_{1-z}Zr_{z}O₃ (0≤x≤1, 0≤y≤1, 0≤z≤1). Examples of this type of oxide include strontium barium titanate, calcium barium titanate, barium zirconate, barium zirconate titanate, calcium zirconate titanate, and calcium barium zirconate titanate.

The dielectric layers 11 may include an additive. In one aspect, the dielectric layers 11 contain Fe as an additive. In one aspect, the dielectric layers 11 contain Fe₃O₄. In one aspect, the dielectric layers 11 contain Fe₂O₃. In one aspect, the dielectric layers 11 contain Fe₃O₄ and Fe₂O₃. Since Fe₃O₄ is a mixed oxide containing Fe²⁺ and Fe³⁺, Fe is present in the dielectric layers 11 as divalent Fe²⁺ and trivalent Fe³⁺. In other words, the dielectric layers 11 contain divalent Fe²⁺ and trivalent Fe³⁺. In this specification, Fe refers to the element iron (Fe), and may also collectively refer to divalent Fe²⁺ and trivalent Fe³⁺.

In one aspect, Fe in the dielectric layers 11 is located at the B site of the oxide having a perovskite structure. The Fe located at the B site of the perovskite structure may be either Fe²⁺ or Fe³⁺.

The dielectric layers 11 may contain additives other than Fe. The additives other than Fe that may be contained in the dielectric layers 11 are Mo (molybdenum), Nb (niobium), Ta (tantalum), W (tungsten), Mg (magnesium), Mn (manganese), V (vanadium), Cr (chromium), oxides of rare earth elements (Y (yttrium), Sm (samarium), Eu (europium)), Gd (gadolinium), Tb (terbium), Dy (dysprosium), Ho (holmium), Er (erbium), Tm (thulium) and Yb (ytterbium)), or oxides containing Co (cobalt), Ni (nickel), Li (lithium), B (boron), Na (sodium), K (potassium) or Si (silicon), or glasses containing Co, Ni, Li, B, Na, K, or Si.

In one aspect, the thickness (the dimension in the lamination direction) of each dielectric layer 11 is 0.02 to 5 μm. The lower limit for the thickness of the dielectric layer 11 may be 0.5 μm. The upper limit for the thickness of the dielectric layer 11 may be 3 μm.

### (1-3) First Internal Electrode Layers 21 and Second Internal Electrode Layers 22

In one aspect, the first internal electrode layers 21 contain a base metal such as Ni (nickel), Cu (copper), and Sn (tin), as the main component thereof. A component that is at least 50 wt % of the first internal electrode layers 21 with reference to the total mass of the first internal electrode layers 21 can be regarded as the main component of the first internal electrode layers 21. The first internal electrode layers 21 can contain additive metal elements in addition to the main component metal element. The additive metal elements that can be contained in the first internal electrode layers 21 are, for example, metals that are more noble than the main component metal of the first internal electrode layers 21 and the second internal electrode layers 22. The additive metal elements that can be contained in the first internal electrode layers 21 are one or more elements selected from the group consisting of, for example, Au, Sn, Cr, Y, In (indium), As (arsenic), Co, Cu, Ir (iridium), Mg, Os (osmium), Pd, Pt, Re (rhenium), Rh (rhodium), Ru (ruthenium), Se (selenium), Te (tellurium), W and Zn (zinc). The description of the first internal electrode layers 21 made in this paragraph also applies to the second internal electrode layers 22.

### (1-4) First External Electrode 31 and Second External Electrode 32

In one aspect, the first and second external electrodes 31 and 32 are formed by applying a conductive paste to the body 10 and heating the conductive paste. The conductive paste can contain one or more of Ag (silver), Pd (palladium), Au (gold), Pt (platinum), Ni (nickel), Sn (tin), Cu (copper), W (tungsten), Ti (titanium), and alloys of these.

### (1-5) First Intermediate Layers 41 and Second Intermediate Layers 42

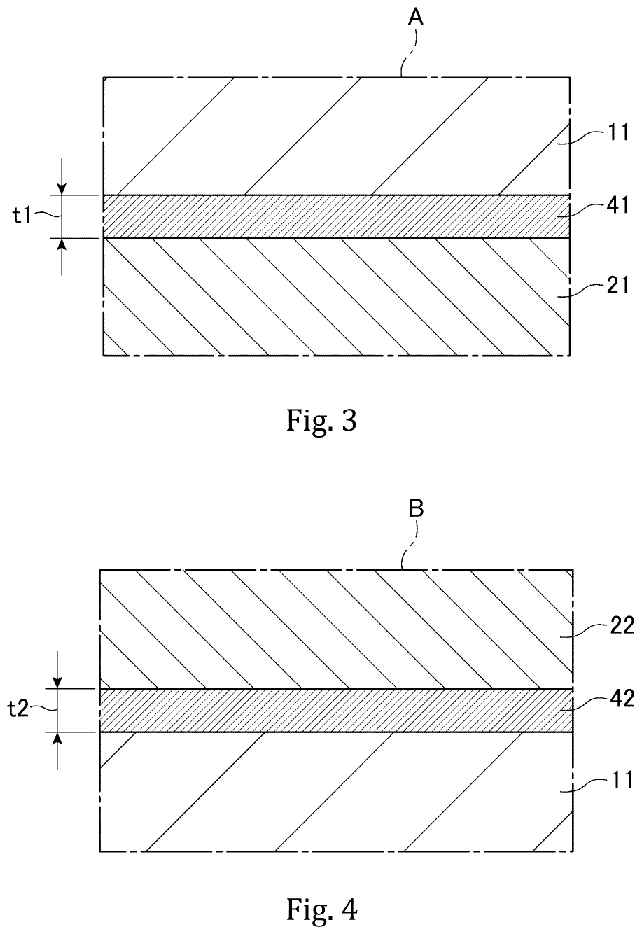

Next, with further reference to FIG. 3 and FIG. 4, a description is given of the first intermediate layers 41 and the second intermediate layers 42. FIG. 4 is an enlarged sectional view of the region A in the section of the body 10 shown in FIG. 2, and FIG. 4 is an enlarged sectional view of the region B in the section of the body 10 shown in FIG. 2. The region A extends from the dielectric layer 11 to the first internal electrode layer 21. The region B extends from the dielectric layer 11 to the second internal electrode layer 22.

In the capacitor 1, the dielectric layers 11 can be made thinner to reduce the size of the capacitor 1 and increase the capacitance of the capacitor 1. In one embodiment, as shown in FIG. 3, the first intermediate layer 41 containing Fe is provided between the dielectric layer 11 and the first internal electrode layer 21, thereby increasing the electrical barrier formed between the dielectric layer 11 and the first internal electrode layer 21. The increased electrical barrier formed between the dielectric layer 11 and the first internal electrode layer 21 extends the lifespan of the capacitor 1 (i.e., improves its insulation reliability).

The first intermediate layer 41 may cover the entire first internal electrode layer 21. The first intermediate layer 41 may cover only a part of the first internal electrode layer 21. The first intermediate layer 41 should preferably cover 70% or more of the entire top and bottom surfaces of the first internal electrode layer 21. The first intermediate layer 41 should more preferably cover 80% or more of the entire top and bottom surfaces of the first internal electrode layer 21.

In one embodiment, as shown in FIG. 4, the second intermediate layer 42 containing Fe is provided between the dielectric layer 11 and the second internal electrode layer 22, thereby increasing the electrical barrier formed between the dielectric layer 11 and the second internal electrode layer 22. This ensures the insulation reliability of the capacitor 1. The increased electrical barrier formed between the dielectric layer 11 and the second internal electrode layer 22 extends the lifespan of the capacitor 1 (i.e., improves its insulation reliability).

The second intermediate layer 42 may cover the entire second internal electrode layer 22. The second intermediate layer 42 may cover only a part of the second internal electrode layer 22. The second intermediate layer 42 should preferably cover 70% or more of the entire top and bottom surfaces of the second internal electrode layer 22. The second intermediate layer 42 should more preferably cover 80% or more of the entire top and bottom surfaces of the second internal electrode layer 22.

The boundary between the first intermediate layer 41 and the dielectric layer 11 or the first internal electrode layer 21 and the boundary between the second intermediate layer 42 and the dielectric layer 11 or the second internal electrode layer 22 are not necessarily clearly visible in the electron microscope image of the section of the body 10.

If the first intermediate layer 41 is not visible in the electron microscope image, the presence of the first intermediate layer 41 can be confirmed based on the mapping data of Fe element obtained by energy dispersive X-ray analysis (EDS) on the TEM image of the region A in the section of the body 10. Specifically, the mapping data of Fe element obtained by EDS on the region A of the section of the body 10 can be reconstructed along an imaginary line extending from the dielectric layer 11 to the first internal electrode layer 21 along the lamination direction (the T axis direction in the example shown in the drawings), so as to obtain the line profile of the amount (count value) of Fe element present along the imaginary line. The line profile is represented as a graph of the count value of Fe element at each detection position on the imaginary line. The count value of the Fe element indicates the intensity of detection of Fe element. If a peak appears in the line profile of Fe element along the imaginary line, it can be confirmed that the first intermediate layer 41 is present between the dielectric layer 11 and the first internal electrode layer 21.

If a peak appears in the line profile of Fe element along the imaginary line extending along the T axis, the positions on both sides of the peak of the line profile at which the count value is half the peak count value can be regarded as the boundary between the first intermediate layer 41 and the dielectric layer 11 and the boundary between the first intermediate layer 41 and the first internal electrode layer 21. The thickness t1 (dimension in the T-axis direction) of the first intermediate layer 41 determined in this manner is, for example, from 0.5 nm to 3.0 nm. The thickness t1 of the first intermediate layer 41 may be from 0.5 nm to 2.0 nm, or from 0.5 nm to 1.3 nm.

In one aspect, the concentration of Fe in the first intermediate layer 41 is higher than the concentration of Fe in the dielectric layer 11. In the line profile of the count values of Fe element obtained by reconstructing the mapping data of Fe element along the imaginary line extending from the dielectric layer 11 to the first internal electrode layer 21 along the T axis direction, when the count value of Fe element in the region included in the first intermediate layer 41 is larger than the count value of Fe element in the region included in the dielectric layer 11, it can be determined that the concentration of Fe in the first intermediate layer 41 is higher than the concentration of Fe in the dielectric layer 11.

In one aspect, the concentration of Fe in the first intermediate layer 41 is higher than the concentration of Fe in the first internal electrode layer 21. In the line profile of the count values of Fe element along the imaginary line, when the count value of Fe element in the region included in the first intermediate layer 41 is larger than the count value of Fe element in the region included in the first internal electrode layer 21, it can be determined that the concentration of Fe in the first intermediate layer 41 is higher than the concentration of Fe in the first internal electrode layer 21.

If the second intermediate layer 42 is not visible in the electron microscope image, the presence of the second intermediate layer 42 can be confirmed based on the mapping data of Fe element obtained by energy dispersive X-ray analysis (EDS) on the TEM image of the region B in the section of the body 10. The determination of the presence of the second intermediate layer 42 can be made in the same manner as the determination of the presence of the first intermediate layer 41 described above. The thickness t2 of the second intermediate layer 42 can be determined in the same manner as the thickness t1 of the first intermediate layer 41 described above. The thickness t2 of the second intermediate layer 42 can be about the same as the thickness t1 of the first intermediate layer 41, specifically, from 0.5 nm to 3.0 nm. The thickness t2 of the second intermediate layer 42 may be from 0.5 nm to 2.0 nm, or from 0.5 nm to 1.3 nm.

In one aspect, at least one of the first intermediate layer 41 or the second intermediate layer 42 also contains the main component metal element (e.g., Ni) of the first internal electrode layer 21 and the second internal electrode layer 22. In one aspect, at least one of the first intermediate layer 41 or the second intermediate layer 42 also contains an additive metal element (e.g., Au) contained in the first internal electrode layer 21 and the second internal electrode layer 22.

In one aspect, at least one of the first internal electrode layer 21 or the second internal electrode layer 22 contains Fe. As described above, the dielectric layer 11 contains Fe.

(1-6) Fe²⁺ and Fe³⁺ Contained in Dielectric Layers 11

As described below in detail, the body 10 is produced by heating a compact containing precursor of each of the dielectric layers 11, the first internal electrode layers 21, and the second internal electrode layers 22, in a low-oxygen atmosphere with an oxygen partial pressure of about 10⁻⁹ to 10⁻¹² MPa. Since this heat treatment is performed in the low-oxygen atmosphere, most of Fe contained in the compact combines with the oxygen present in the atmosphere to form Fe₃O₄, while little Fe₂O₃ is formed. Therefore, in conventional capacitors, most of Fe added to the raw material is contained in the body 10 as Fe₃O₄. Since Fe₃O₄ is a mixed oxide containing Fe²⁺ and Fe³⁺, hopping of free electrons occurs between the Fe₃O₄ particles contained in the dielectric layers 11. Therefore, the Fe₃O₄ present in the dielectric layers 11 causes reduction of the insulation resistance of the dielectric layers 11.

If the iron oxide contained in the dielectric layers 11 is Fe₂O₃ having an insulating property, the insulation resistance of the dielectric layers 11 will not decrease. Since Fe₂O₃ is an oxide of Fe³⁺, which is highly stable, and therefore releases almost no free electrons. However, in order to form Fe₂O₃ during the heat treatment of the compact, the heat treatment needs to be performed in an atmosphere with a high oxygen partial pressure. If the heat treatment is performed in an atmosphere with a high oxygen partial pressure that allows the formation of Fe₂O₃, oxidation of the main component metal (e.g., Ni) of the precursor of the first internal electrode layers 21 and the second internal electrode layers 22 will proceed. Therefore, the heat treatment cannot be performed in an atmosphere with a high oxygen partial pressure.

Fe₃O₄ contains twice as many Fe³⁺ ions as Fe²⁺ ions in terms of atomic ratio. In other words, the atomic ratio of Fe²⁺ to Fe³⁺ contained in Fe₃O₄ (i.e., Fe²⁺/Fe³⁺) is 1/2. This means that the atomic ratio of Fe²⁺ to the total of Fe²⁺ and Fe³⁺ is approximately 0.33 for Fe₃O₄.

In this embodiment, the atomic ratio of Fe²⁺ to the total of Fe²⁺ and Fe³⁺ (hereinafter also referred to as the “Fe²⁺ content ratio”) in the dielectric layers 11 is 0.4 or higher, which improves the insulation resistance of the dielectric layers 11. The improvement in the insulation resistance of the dielectric layers 11 is considered to be due to the inhibition of free electron hopping in the dielectric layers 11, resulting from an increased content ratio of Fe²⁺ within the dielectric layers 11.

The Fe²⁺ content ratio in the dielectric layers 11 can be evaluated, for example, by X-ray absorption near edge structure (XANES) analysis. Specifically, in the section of the capacitor 1, an X-ray absorption fine structure (XAFS) spectrum is measured, and from this XAFS spectrum, the X-ray absorption near edge structure (XANES) spectrum is obtained. In the XANES spectrum, the peak having a peak top located at 7008 to 7012 eV is identified as the Fe²⁺ peak, and its peak area is calculated. Also, the peak having a peak top located at 7013 to 7016 eV is identified as the Fe³⁺ peak, and its peak area is calculated. The peak area of Fe²⁺ represents the atomic percentage (at %) of Fe²⁺ present in the evaluation region of the section of the capacitor 1, while the peak area of Fe³⁺ represents the atomic percentage (at %) of Fe³⁺ present in the same region. Therefore, the Fe²⁺ content ratio can be expressed based on the peak areas of Fe²⁺ and Fe³⁺ by the following formula (1).

$$( {Fe}^{2 +} peak area ) / \{ ( {Fe}^{2 +} peak area ) + ( {Fe}^{3 +} peak area ) \} \qquad ( 1 )$$

In this embodiment, when Fe₃O₄ is contained in the dielectric layers 11, the Fe²⁺ content ratio within the dielectric layers 11 is increased to a value greater than 0.33, which is the Fe²⁺ content ratio in Fe₃O₄, thereby improving the insulation resistance of the dielectric layers 11.

In one aspect, during the manufacturing process of the capacitor 1, the compact is subjected to heat treatment, and then the heated compact is subjected to annealing treatment, thereby reducing Fe³⁺ contained in the dielectric layers 11 to Fe²⁺. Since the heated compact is subjected to the annealing treatment, the amount of Fe²⁺ contained in the dielectric layers 11 can be increased, allowing the Fe²⁺ content ratio in the dielectric layers 11 to be greater than 0.4.

In one embodiment, an additive element having a greater ionization tendency than Fe can be added to the raw material of the dielectric layers 11, such that it is less likely that Fe loses electrons during the heat treatment of the compact. Therefore, with an additive element having a greater ionization tendency than Fe added to the raw material of the dielectric layers 11, the amount of Fe²⁺ contained in the dielectric layers 11 can be increased compared to the case where such an additive element is not added. Thus, with an additive element having a greater ionization tendency than Fe added to the precursor of the dielectric layers 11, the amount of Fe²⁺ contained in the dielectric layers 11 can be increased, allowing the Fe²⁺ content ratio in the dielectric layers 11 to be 0.4 or greater. In one aspect, the additive element having a greater ionization tendency than Fe is one or more elements selected from the group consisting of Al, Sn, and Si.

The ratio (atomic ratio) of the amount (at %) of the above additive element to the amount (at %) of Fe contained in the raw material of the dielectric layers 11 is from 0.1 to 3. If the amount of additive element is excessive relative to the amount of Fe added, the added Fe will be consumed by the bonding of the additive element, and thus the first intermediate layer 41 cannot be formed between the dielectric layer 11 and the first internal electrode layer 21, and the second intermediate layer 42 cannot be formed between the dielectric layer 11 and the second internal electrode layer 22. For this reason, the upper limit of the ratio of the amount (at %) of the above additive element to the amount (at %) of Fe added is set at 3.0. If the amount of the additive element is too small relative to the amount of Fe added, the Fe²⁺ content in the dielectric layers 11 can hardly be increased. For this reason, the lower limit of the ratio of the amount (at %) of the above additive element to the amount (at %) of Fe added is set at 0.1.

The Fe²⁺ ions contained in the dielectric layers 11 extract oxygen from the oxide, such as barium titanate, which is the main component of the dielectric layer 11, in order to form Fe³⁺ ions, which are more stable. The oxide from which oxygen is extracted by Fe²⁺ has oxygen defects. The oxygen defects generated in the oxide, which is the main component of the dielectric layer 11, move toward the first internal electrode layer 21 or the second internal electrode layer 22 upon application of voltage to the capacitor 1. The oxygen defects that have moved to the vicinity of the first internal electrode layer 21 or the second internal electrode layer 22 generate an electric field near the interface between the dielectric layer 11 and the first internal electrode layer 21 or the second internal electrode layer 22, thus lowering the electrical barrier formed by the first intermediate layer 41 and the second intermediate layer 42. In this way, when the amount of Fe²⁺ contained in the dielectric layer 11 is excessive, the insulation reliability is unfavorably decreased by oxygen defects generated in the oxide within the dielectric layer 11.

In one aspect, in order to inhibit the decrease in insulation reliability caused by oxygen defects generated in the oxide within the dielectric layer 11, the content of Fe²⁺ in the dielectric layer 11 is limited so that the Fe²⁺ content ratio is 0.85 or less. This ensures the insulation reliability of the capacitor 1.

In one aspect, the Fe²⁺ content ratio in the dielectric layer 11 is from 0.4 to 0.85. With the lower limit of the Fe²⁺ content ratio set at 0.4, a decrease in the insulation resistance of the dielectric layer 11 can be inhibited, and with the upper limit of the Fe²⁺ content ratio set at 0.85, the insulation reliability of the capacitor 1 can be ensured. The Fe²⁺ content ratio in the dielectric layer 11 may be from 0.5 to 0.75. The Fe²⁺ content ratio in the dielectric layer 11 may be from 0.55 to 0.7.

### (2) First Manufacturing Method

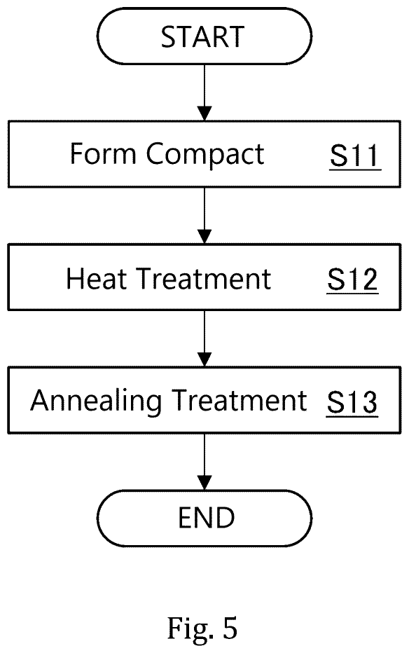

A description will now be given of one example of the manufacturing method of the capacitor 1 with reference to FIG. 5. FIG. 5 is a flowchart showing a flow of a production method of a capacitor according to one embodiment of the disclosure.

Here is a brief description of the manufacturing method shown in FIG. 5. In step S11, a compact as the precursor of the body 10 is formed. The compact includes dielectric green sheets, which are the precursor of the dielectric layers 11, and a conductive paste formed on the dielectric green sheets. The conductive paste is the precursor of the first internal electrode layer 21 and the second internal electrode layer 22. At least one of the dielectric green sheets or the conductive paste contains Fe. Next, in step S12, the compact produced in step S11 is subjected to heat treatment in a low-oxygen atmosphere. The compact heated in step S12 is then subjected to annealing treatment in step S13. Through the annealing treatment, the capacitor 1 is obtained. During the annealing treatment, a part of Fe³⁺ contained in the compact is reduced to Fe²⁺. The annealing treatment is performed under such conditions that the Fe²⁺ content ratio can be from 0.4 to 0.85.

The following describes each of the steps of the manufacturing method shown in FIG. 5 in more detail. First, in the step S11, dielectric powder is wet-mixed with a binder such as polyvinyl butyral (PVB) resin, an organic solvent such as ethanol or toluene, and a plasticizer to obtain a slurry. This slurry is coated on a substrate film using, for example, the die coater or doctor blade method, and then the slurry coated on the substrate film is dried, to obtain a dielectric green sheet. The dielectric green sheets are the precursor of the dielectric layers 11.

The dielectric powder used as the raw powder of the dielectric green sheets is, for example, barium titanate powder. Barium titanate powder is synthesized by reacting titanium raw material such as titanium dioxide with barium raw material such as barium carbonate by a known method such as the solid phase method, the sol-gel method, or the hydrothermal method.

The raw powder of the dielectric green sheets may be a mixed powder, which is a mixture of the dielectric powder and an additive. The additive added to the dielectric powder may be Fe. When Fe is added to the dielectric powder, the atomic ratio of Fe to Ti in the dielectric powder is from 0.01 to 3.

Next, in step S11, an internal electrode pattern is formed on each of the dielectric green sheets. The internal electrode patterns formed on some of the dielectric green sheets are the precursor of the first internal electrode layers 21, and the internal electrode patterns formed on the others of the dielectric green sheets are the precursor of the second internal electrode layers 22. The internal electrode patterns contain base metals such as Ni, Cu, and Sn, which are the main component of the first and second internal electrode layers 21 and 22. The internal electrode patterns may contain Fe in addition to the base metals that are the main component of the first and second internal electrode layers 21 and 22.

Both the dielectric green sheet and the internal electrode pattern may contain Fe, or only one of the dielectric green sheet and the internal electrode pattern may contain Fe.

The internal electrode patterns may be formed by printing a paste for the internal electrodes on the dielectric green sheets using screen printing or other known printing methods. The internal electrode patterns may be formed on the dielectric green sheets by the sputtering method. The method of forming the internal electrode patterns is not limited to those specified herein. The internal electrode patterns may be formed by various known methods, e.g., vacuum deposition, pulsed laser deposition (PLD), metal organic chemical vapor deposition (MO-CVD), metal organic decomposition (MOD), or chemical solution deposition (CSD).

When the internal electrode patterns are formed by screen printing, the paste for the internal electrodes is produced by kneading and mixing a metal powder, a binder resin, and a solvent by a three-roll mill. The paste for the internal electrodes is produced by dispersing the metal powder in the binder resin.

The metal powder as the raw material of the paste for the internal electrodes is, for example, base metal powder such as Ni, Cu, and Sn. The raw powder of the paste for the internal electrodes may be a mixed powder made of the base metal powder and Fe powder. The Fe powder may be Fe oxide powder (e.g., Fe₂O₃ powder) or alloy powder made of Fe and the main component metal. The organic binder may be a cellulose-based resin such as ethyl cellulose or an acrylic resin such as butyl methacrylate.

When forming the internal electrode patterns by the sputtering method, a conductor target containing base metals such as Ni, Cu, and Sn is sputtered under predetermined film-forming conditions, and the sputtered particles generated at this time are deposited on the dielectric green sheets. The conductor target may contain Fe as well as base metals.

Next, the dielectric green sheet with an internal electrode pattern formed on the surface thereof is removed from the substrate film. The dielectric green sheets each having an internal electrode pattern formed on the surface thereof are prepared in this way, and a predetermined number of such dielectric green sheets are stacked and thermocompressed to obtain a laminate. The top layer and the bottom layer of the laminate may be formed of green sheets that do not have internal electrode patterns formed thereon.

Next, the laminate is diced into pieces to obtain compacts each being the precursor of the body 10. The chip compacts obtained in step S11 may be subjected to a degreasing process. The degreasing process may be performed in an N₂ atmosphere. The compacts having undergone the degreasing process may be coated with a metal paste by the dip method to form base layers for the first and second external electrodes 31 and 32.

The chip compact produced in step S11 is then fired in step S12. Specifically, heat treatment is performed on the chip compacts according to the following heating conditions.
Atmosphere: low-oxygen atmosphere (oxygen partial pressure of 10⁻⁹ to 10⁻¹² MPa)
Heating temperature: 1160 to 1280° C.
Heating time: 10 minutes to 2 hours

When Fe is heated in a low-oxygen atmosphere, Fe is oxidized to form Fe₃O₄. In the heat treatment in a low-oxygen atmosphere with an oxygen partial pressure of about 10⁻⁹ to 10⁻¹² MPa, Fe₂O₃ is not formed or is formed only in a very small amount. The chip compacts produced in step S11 contain Fe in the form of Fe₃O₄.

In the heat treatment in step S12, Fe contained in the precursor of the dielectric layer 11 and the precursor of the first internal electrode layer 21 and/or the second internal electrode layer 22 moves to the interface between the precursor of the dielectric layer 11 and the precursor of the first internal electrode layer 21 and the interface between the precursor of the dielectric layer 11 and the precursor of the second internal electrode layer 22. Therefore, the first intermediate layer 41 containing Fe is formed at the interface between the precursor of the dielectric layer 11 and the precursor of the first internal electrode layer 21, and the second intermediate layer 42 containing Fe is formed at the interface between the precursor of the dielectric layer 11 and the precursor of the second internal electrode layer 22.

The fired compact obtained in step S12 is then subjected to the annealing treatment in step S13 to obtain the capacitor 1.

Specifically, in step S13, the fired compact is subjected to heat treatment in a strongly reducing atmosphere with a lower oxygen partial pressure than during firing. Examples of specific heating conditions are as follows.
Atmosphere: strongly reducing atmosphere (oxygen partial pressure of 10⁻¹³ to 10⁻¹⁴ MPa)
Heating temperature: 1100 to 1150° C.
Heating time: 1 hour to 2 hours

Through the annealing treatment in step S13, the Fe₃O₄ contained in the compact is reduced. Therefore, the Fe₃O₄ content in the body 10 after the annealing treatment is smaller than the Fe₃O₄ content in the compact before the annealing treatment. In terms of Fe valence, the Fe³⁺ contained in the compact before the annealing treatment is reduced to Fe²⁺. Thus, the annealing treatment performed on the fired compact can increase the amount of Fe²⁺ contained in the dielectric layer 11 compared to the case where the annealing treatment is not performed. The annealing treatment in step S13 is performed under the heating conditions adjusted so that the atomic ratio of Fe²⁺ contained in the dielectric layer 11 to the total of Fe²⁺ and Fe³⁺ contained in the dielectric layer 11 (Fe²⁺ content ratio: Fe²⁺/(Fe²⁺+Fe³⁺)) falls within the range from 0.4 to 0.85.

Processes not shown in the flowchart of FIG. 5 may be performed to produce the capacitor 1. For example, the capacitor 1 obtained through the annealing treatment in step S13 may be subjected to re-oxidation treatment at 600° C. to 1000° C. in an N₂ gas atmosphere. A plating layer of Cu, Ni, Sn or the like may be provided on the surfaces of the first and second external electrodes 31 and 32. This plating layer can be formed by the electrolytic or electroless plating method.

### (3) Second Manufacturing Method

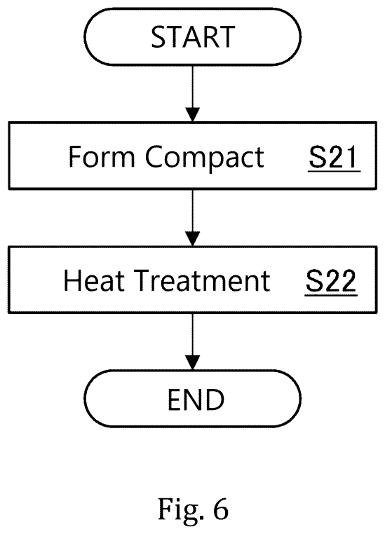

A description will now be given of another manufacturing method of the capacitor 1 with reference to FIG. 6. The manufacturing method shown in FIG. 6 differs from the method shown in FIG. 5 in the technique for reducing Fe³⁺ in the compact. Specifically, in the manufacturing method shown in FIG. 6, the fired compact is not subjected to the annealing treatment, but an additive element having a greater ionization tendency than Fe is added to the dielectric green sheets to promote the formation of Fe²⁺ during firing. The following describes the manufacturing method shown in FIG. 6 in more detail. In the manufacturing method shown in FIG. 6, the same matters as in the manufacturing method shown in FIG. 5 are not described, for the sake of brevity of description.

First, in step S21, a compact is formed as the precursor of the body 10. Specifically, mixed powder is obtained by mixing dielectric powder, Fe powder, and powder of an additive element having a greater ionization tendency than Fe. In one aspect, the additive element having a greater ionization tendency than Fe contained in the mixed powder is one or more elements selected from the group consisting of Al, Sn, and Si. The content ratio of the additive element having a greater ionization tendency than Fe relative to the atomic percentage (at %) of Fe in the mixed powder is from 0.1 to 3. In other words, the atomic ratio of the content of the additive element to the content of Fe in the mixed powder is from 0.1 to 3.

Next, the above mixed powder is wet-mixed with a binder such as polyvinyl butyral (PVB) resin, an organic solvent such as ethanol or toluene, and a plasticizer to obtain a slurry. This slurry is coated on a substrate film using, for example, the die coater or doctor blade method, and then the slurry coated on the substrate film is dried, to obtain a dielectric green sheet. The dielectric green sheets are the precursor of the dielectric layers 11. The atomic ratio of Fe to Ti in the dielectric powder is from 0.01 to 3.

Next, an internal electrode pattern is formed on each of the dielectric green sheets. The internal electrode patterns formed on some of the dielectric green sheets are the precursor of the first internal electrode layers 21, and the internal electrode patterns formed on the others of the dielectric green sheets are the precursor of the second internal electrode layers 22. The internal electrode patterns contain base metals such as Ni, Cu, and Sn, which are the main component of the first and second internal electrode layers 21 and 22. The internal electrode patterns may contain Fe in addition to the base metals that are the main component of the first and second internal electrode layers 21 and 22.

Both the dielectric green sheet and the internal electrode pattern may contain Fe, or only one of the dielectric green sheet and the internal electrode pattern may contain Fe.

Next, the dielectric green sheet with an internal electrode pattern formed on the surface thereof is removed from the substrate. The dielectric green sheets each having an internal electrode pattern formed on the surface thereof are prepared in this way, and a predetermined number of such dielectric green sheets are stacked and thermocompressed to obtain a laminate. The top layer and the bottom layer of the laminate may be formed of green sheets that do not have internal electrode patterns formed thereon.

Next, the laminate is diced into pieces to obtain compacts each being the precursor of the body 10. The chip compacts obtained in step S21 may be subjected to a degreasing process. The degreasing process may be performed in an N₂ atmosphere. The compacts having undergone the degreasing process may be coated with a metal paste by the dip method to form base layers for the first and second external electrodes 31 and 32.

Next, in step S22, the chip compact produced in step S21 is fired under the same heating conditions as in step S12 to obtain the capacitor 1.

In the chip compact produced in step S21, the regions that are the precursor of the dielectric layers 11 contain an additive element having a larger ionization tendency than Fe along with Fe. Therefore, the Fe contained in the chip compact produced in step S21 is less likely to lose electrons during firing than the Fe contained in the compact not containing the additive element Therefore, in the dielectric layers 11 of the body 10 obtained by the firing in step S22, the Fe²⁺ content ratio (Fe²⁺/(Fe²⁺+Fe³⁺)) can be increased compared to the case where no additive element is added to the precursor. Thus, with an additive element having a greater ionization tendency than Fe added to the precursor of the dielectric layers 11, the amount of Fe²⁺ contained in the dielectric layers 11 can be increased, allowing the Fe²⁺ content ratio in the dielectric layers 11 to be 0.4 or greater.

In the heat treatment in step S22, Fe contained in the precursor of the dielectric layer 11 moves to the interface between the precursor of the dielectric layer 11 and the precursor of the first internal electrode layer 21 and the interface between the precursor of the dielectric layer 11 and the precursor of the second internal electrode layer 22. If the precursor of the first internal electrode layer 21 and/or the precursor of the second internal electrode layer 22 also contain Fe, such Fe also moves to the interface between the precursor of the dielectric layer 11 and the precursor of the first internal electrode layer 21 and the interface between the precursor of the dielectric layer 11 and the precursor of the second internal electrode layer 22. Therefore, the first intermediate layer 41 containing Fe is formed at the interface between the precursor of the dielectric layer 11 and the precursor of the first internal electrode layer 21, and the second intermediate layer 42 containing Fe is formed at the interface between the precursor of the dielectric layer 11 and the precursor of the second internal electrode layer 22.

If the dielectric green sheets in the compact contain an excessive amount of additive element having a greater ionization tendency than Fe, the combination of Fe and the additive element prevents the movement of Fe, failing to increase the electrical barrier by the first and second intermediate layers 41 and 42. In the above manufacturing method, the powders are mixed to produce the mixed powder contained in the raw material of the dielectric green sheets in such a manner that the atomic ratio of the content of the additive element to the content of Fe is 3 or less. As a result, the movement of Fe is not excessively restricted. Therefore, in the capacitor 1 produced by the above manufacturing method, the electrical barrier between the dielectric layer 11 and the first internal electrode layer 21 can be increased by the first intermediate layer 41 interposed between the dielectric layer 11 and the first internal electrode layer 21. Also, the electrical barrier between the dielectric layer 11 and the second internal electrode layer 22 can be increased by the second intermediate layer 42 interposed between the dielectric layer 11 and the second internal electrode layer 22.

### (4) Examples

Examples hereinafter described will illustrate the present invention more specifically, but the present invention is not limited to these Examples.

Samples to be evaluated were prepared according to the manufacturing method shown in FIG. 5, as follows. First, Fe powder was added to the barium titanate powder to accomplish the atomic ratios listed in the column “Fe/Ti” of Table 1 below, and the barium titanate powder and the Fe powder were mixed to obtain the mixed powders to be used as raw materials for samples 1 to 7. For example, for the mixed powder used to produce sample 1, the barium titanate powder and the Fe powder were weighed so that the atomic ratio of Fe to Ti was 0.01, as shown in Table 1, and these powders weighed were mixed.

TABLE 1

| | | | Fe²⁺ | | | |
|---|---|---|---|---|---|---|
| | | Annealing | Content | Insulation | Insulation | Passing/ |
| | Fe/Ti | Treatment | Ratio | Reliability | Resistance | Failing |
| Sample 1 | 0.01 | Done | 0.53 | Passing | Passing | Passing |
| (Example 1) | | | | | | |
| Sample 2 | 0.5 | Done | 0.49 | Passing | Passing | Passing |
| (Example 2) | | | | | | |
| Sample 3 | 3 | Done | 0.45 | Passing | Passing | Passing |
| (Example 3) | | | | | | |
| Sample 4 | 0.5 | Undone | 0.37 | Passing | Failing | Failing |
| (Comparative | | | | | | |
| Example 1) | | | | | | |
| Sample 5 | 0.008 | Undone | N/A | Failing | Passing | Failing |
| (Comparative | | | | | | |
| Example 2) | | | | | | |
| Sample 6 | 3.2 | Undone | 0.31 | Passing | Failing | Failing |
| (Comparative | | | | | | |
| Example 3) | | | | | | |
| Sample 7 | 3.2 | Done | 0.35 | Passing | Failing | Failing |
| (Comparative | | | | | | |
| Example 4) | | | | | | |

Next, for each of the mixed powders used to prepare samples 1 to 7, polyvinyl butyral (PVB) resin, a solvent, and a plasticizer were added and wet-mixed to obtain slurries for samples 1 to 7. Each of these slurries was coated on a substrate film, and then the slurry coated on the substrate film was dried to obtain seven types of dielectric green sheets.

Next, a paste for internal electrodes in which Ni was dispersed in a binder resin was printed onto each of the seven types of dielectric green sheets, thereby forming an internal electrode pattern on each of the seven types of dielectric green sheets.

Next, 500 dielectric green sheets of the same type were stacked together to form a laminate, which was then diced into chip compacts. The chip compacts had the 1005 shape (length: 1.0 mm, width: 0.5 mm, height: 0.5 mm). Next, these chip compacts were degreased in an N₂ atmosphere. Following this, metal paste was applied to the degreased compacts by the dip method, to form base layers of the external electrodes on the compacts.

Next, the chip compacts obtained as descried above were subjected to heat treatment according to the following heating conditions.
Atmosphere: low-oxygen atmosphere (oxygen partial pressure of 10⁻¹⁰ MPa)
Heating temperature: 1200° C.
Heating time: 10 minutes

The above process resulted in seven types of fired compacts containing Fe in the dielectric green sheets at the atomic ratios shown in Table 1. Of the seven types of fired compacts for samples 1 to 7, those for samples 1 to 3 and sample 7 were subjected to heat treatment (annealing treatment) according to the following heating conditions.
Atmosphere: strongly reducing atmosphere (oxygen partial pressure of 10⁻¹³ MPa)
Heating temperature: 1140° C.
Heating time: 2 hours

The fired compacts for samples 4 to 6 were not subjected to the annealing treatment

Samples 1 to 7 were prepared as described above. In samples 1 to 7, the dielectric green sheets were fired to form the dielectric layers, and the internal electrode patterns were fired to form the internal electrode layers. The base layers formed on the compacts were fired to form the external electrodes. Therefore, samples 1 to 7 are all capacitors in which the dielectric layers and internal electrode layers are arranged alternately along the T-axis direction.

Next, each of samples 1 to 7 was ground along the LT plane in FIG. 1 to expose a section parallel to the LT plane for samples 1 to 7. For each of the sections of samples 1 to 7, the XAFS spectrum was measured in a region within the dielectric layer formed of the sintered dielectric green sheet, and the XANES spectrum was obtained from the XAFS spectrum. In the XANES spectrum of each sample, the peak having a peak top located at 7008 to 7012 eV was identified as the Fe²⁺ peak, and its peak area was calculated. Similarly, the peak having a peak top located at 7013 to 7016 eV was identified as the Fe³⁺ peak, and its peak area was calculated. Using the Fe²⁺ peak area and the Fe³⁺ peak area thus obtained, the Fe²⁺ content ratio was calculated in accordance with the above-described formula (1). The Fe²⁺ content ratio calculated for each sample is shown in the column “Fe²⁺ Content Ratio” of Table 1. For sample 5, having an extremely small amount of Fe added, the Fe²⁺ and Fe³⁺ peaks could not be observed in the XANES spectrum, and therefore the Fe²⁺ content ratio was not calculated.

Next, a reliability test was performed on each of samples 1 to 7. In the reliability test, a voltage of 6.3 V was applied at 85° C. for 1,000 hours and 2,000 hours, followed by storage at room temperature for 24 hours, after which the insulation resistance was evaluated. Samples with insulation resistance less than 10 MΩ were determined to be defective. If no failure occurred after 1,000 hours, the sample was determined to be “Passing”, and if a failure occurred after less than 1,000 hours, the sample was determined to be “Failing”. The results of this determination are shown in the column “Insulation Reliability” of Table 1.

As shown in Table 1, samples 1 to 4 and samples 6 to 7 were determined to be “Passing” in the reliability test, as no failure occurred after 1,000 hours. In samples 1 to 4 and samples 6 to 7, the atomic ratio of Fe to Ti in the dielectric green sheet, which is the precursor of the observation region, is 0.01 or higher. Therefore, it is considered that Fe moved to the interfaces between the dielectric green sheet and the internal electrode patterns during firing, and after sintering in the samples 1 to 4 and samples 6 to 7, Fe was segregated between the dielectric layer and the internal electrode layers. In samples 1 to 4 and samples 6 to 7, it is considered that an Fe-containing segregated layer formed between the dielectric layer and the internal electrode layers increased the electrical barrier between the dielectric layer and the internal electrode layers, resulting in high insulation reliability. On the other hand, in sample 5, it is considered that the electrical barrier between the dielectric layer and the internal electrode layers was not sufficiently increased due to the low Fe content in the dielectric green sheet, and as a result, the insulation reliability was deteriorated.

Next, an insulation resistance test was performed on each of samples 1 to 7. In the insulation resistance test, the DC resistance (IR value) was calculated for each of samples 1 to 7 from the leakage current generated when a voltage of 10 V was applied between the external electrodes. Samples with the measured IR value of 100 MΩ or higher were determined to be “Passing”, and those with the measured IR value of less than 100 MΩ were determined to be “Failing”. The results of this determination are shown in the column “Insulation Resistance” of Table 1.

As shown in Table 1, samples 1 to 3 and sample 5 were determined to be “Passing” in the insulation resistance test, as the measured IR values were 100 MΩ or higher. On the other hand, sample 4 and samples 6 to 7 were determined to be “Failing” in the insulation resistance test, as the measured JR values were less than 100 MΩ.

Since all of samples 1 to 7 were produced by firing a compact including a dielectric green sheet under a low-oxygen atmosphere, the Fe contained in the dielectric green sheet is considered to have been oxidized during firing, forming Fe₃O₄ in the fired compact, which causes a reduction in the insulation property. Samples 1 to 3 were subjected to the annealing treatment after firing, and during this annealing treatment, Fe³⁺ contained in the fired compact was reduced to Fe²⁺, resulting in an increase in the Fe²⁺ content ratio to the range of 0.45 to 0.53. This indicates that, in samples 1 to 3, the content of Fe₃O₄ in the dielectric layer has decreased compared to that in the sintered compacts as their respective precursors. Thus, in samples 1 to 3, the Fe₃O₄ content is considered to have decreased to such a level that the Fe²⁺ content ratio reached the range of 0.45 to 0.53, resulting in an improvement in DC resistance.

On the other hand, in manufacturing samples 4 and 6, the annealing treatment was not performed after firing, and therefore, the Fe²⁺ content ratio remained within the range from 0.31 to 0.37, approximately around 0.33. Accordingly, the dielectric layers of samples 4 and 6 contain a larger amount of Fe₃O₄ than those of samples 1 to 3, and this relatively large amount of Fe₃O₄ is considered to have caused a reduction in the DC resistance value of samples 4 and 6 to below 100 MΩ.

Sample 7 was subjected to the annealing treatment after sintering, as with samples 1 to 3, but because of the high Fe content, the sintered compact contains a large amount of Fe₃O₄. The reduction of Fe³⁺ to Fe²⁺ during the annealing treatment is considered to have occurred to some extent, as supported by the fact that the Fe²⁺ content ratio in sample 7 is higher than that in sample 6. Nevertheless, even after the annealing treatment, sample 7 retains a larger amount of Fe₃O₄ than samples 1 to 3, which is considered to have resulted in a decrease in the DC resistance value of sample 7 to below 100 MΩ.

Since sample 5 had only an extremely small amount of Fe added, it is considered that Fe₃O₄ was not generated during the sintering process to such a level that would cause a reduction in insulation resistance, and therefore, the DC resistance value was 100 MΩ or higher.

Samples 1 to 3, which were determined to be “Passing” in both the insulation reliability test and the insulation resistance test described above, were determined to be “Passing” in the overall determination. Samples 1 to 3, which were determined to be “Passing” in the overall determination, maintain excellent insulation reliability accomplished by the intermediate layers formed between the dielectric layer and the internal electrode layers and containing Fe at a high concentration. Additionally, with the Fe²⁺ content ratio in the dielectric layer increased to the range of 0.45 to 0.53, which is higher than 0.33, the hopping conduction of free electrons between Fe₃O₄ molecules in the dielectric layer is inhibited, thereby inhibiting a reduction in insulation resistance of the dielectric layer.

When increasing the Fe²⁺ content in the dielectric layer 11 through the annealing treatment, the Fe²⁺ content ratio in the dielectric layer 11 is considered to be primarily affected by the following parameters.
Fe content in raw materials for the dielectric green sheet and the internal electrode patterns
Oxygen partial pressure in the atmosphere during the annealing treatment
Heating time for the annealing treatment

When the Fe content in the raw materials for the dielectric green sheet and the internal electrode patterns is high, the Fe₃O₄ content in the fired compact also increases. When the Fe₃O₄ content in the fired compact increases, the proportion of Fe³⁺, among Fe³⁺ contained in the compact, that is reduced during the annealing treatment decreases, resulting in a lower Fe²⁺ content ratio in the dielectric layer 11. With the upper limit of the atomic ratio of Fe to Ti in the dielectric powder set at 3 or less, it should be possible to increase the Fe²⁺ content ratio in the dielectric layer 11 to 0.4 or higher through heat treatment for about 1 to 2 hours in a strongly reducing atmosphere with an oxygen partial pressure of about 10⁻¹³ to 10⁻¹⁴ MPa.

In Examples described above, the main component of the dielectric layer is barium titanate as an example, but the same results can be obtained even with oxides other than barium titanate, because the type of the main component of the dielectric has little effect on the oxidation and reduction reactions of Fe.

Samples to be evaluated were prepared according to the manufacturing method shown in FIG. 6, as follows. First, Fe powder was added to the barium titanate powder to accomplish the atomic ratios listed in the column “Fe/Ti” of Table 2 below, and the powder of an additive element having a greater ionization tendency than Fe was added to accomplish the ratios listed in the column “Additive Element/Fe Added” of Table 2. The barium titanate powder was mixed with the Fe powder and the additive element powder to obtain the mixed powders used as the raw materials for samples 8 to 15. The column “Additive Element/Fe Added” in Table 2 lists the amount (at %) of the additive elements listed in the column “Additive Element” divided by the amount of Fe added.

TABLE 2

| | | | Additive | Fe²⁺ | | | |
|---|---|---|---|---|---|---|---|
| | | Additive | Element/ | Content | Insulation | Insulation | Passing/ |
| | Fe/Ti | Element | Fe Added | Ratio | Reliability | Resistance | Failing |
| Sample 8 | 0.5 | Al | 0.2 | 0.68 | Passing | Passing | Passing |
| (Example 4) | | | | | | | |
| Sample 9 | 0.5 | Al | 2.6 | 0.77 | Passing | Passing | Passing |
| (Example 5) | | | | | | | |
| Sample 10 | 0.5 | Si | 0.2 | 0.64 | Passing | Passing | Passing |
| (Example 6) | | | | | | | |
| Sample 11 | 0.5 | Sn | 0.2 | 0.65 | Passing | Passing | Passing |
| (Example 7) | | | | | | | |
| Sample 12 | 3.2 | Al | 0.16 | 0.36 | Passing | Failing | Failing |
| (Comparative | | | | | | | |
| Example 5) | | | | | | | |
| Sample 13 | 0.5 | Al | 0.02 | 0.38 | Passing | Failing | Failing |
| (Comparative | | | | | | | |
| Example 6) | | | | | | | |
| Sample 14 | 0.5 | Al | 3.4 | 0.7 | Failing | Passing | Failing |
| (Comparative | | | | | | | |
| Example 7) | | | | | | | |
| Sample 15 | 0.2 | Al | 10 | 0.89 | Failing | Passing | Failing |
| (Comparative | | | | | | | |
| Example 8) | | | | | | | |

Next, for each of the mixed powders used to prepare samples 8 to 15, polyvinyl butyral (PVB) resin, a solvent, and a plasticizer were added and wet-mixed to obtain slurries for samples 8 to 15. Each of these slurries was coated on a substrate film, and then the slurry coated on the substrate film was dried to obtain eight types of dielectric green sheets.

Next, a paste for internal electrodes in which Ni was dispersed in a binder resin was printed onto each of the eight types of dielectric green sheets, thereby forming an internal electrode pattern on each of the eight types of dielectric green sheets.

Next, 500 dielectric green sheets of the same type were stacked together to form a laminate, which was then diced into chip compacts. The chip compacts had the 1005 shape (length: 1.0 mm, width: 0.5 mm, height: 0.5 mm). Next, these chip compacts were degreased in an N₂ atmosphere. Following this, metal paste was applied to the degreased compacts by the dip method, to form base layers of the external electrodes on the compacts.

Next, the chip compacts obtained as descried above were subjected to heat treatment according to the following heating conditions.
Atmosphere: low-oxygen atmosphere (oxygen partial pressure of 10⁻¹⁰ MPa)
Heating temperature: 1200° C.
Heating time: 10 minutes

Samples 8 to 15 were prepared as described above. In samples 8 to 15, the dielectric green sheets were fired to form the dielectric layers, and the internal electrode patterns were fired to form the internal electrode layers. The base layers formed on the compacts were fired to form the external electrodes. Therefore, samples 8 to 15 are all capacitors in which the dielectric layers and internal electrode layers are arranged alternately along the T-axis direction.

Next, for each of samples 8 to 15, the Fe²⁺ content ratio was calculated by XANES in the same manner as for samples 1 to 7, and the calculated Fe²⁺ content ratios were entered into the column “Fe²⁺ Content Ratio” of Table 2.

Next, a reliability test was performed on each of samples 8 to 15 by the same method as for samples 1 to 7, and determination was made based on the same criteria as to whether each sample was “Passing” or “Failing”.

As shown in Table 2, samples 8 to 13 were determined to be “Passing” in the reliability test, as no failure occurred after 1,000 hours. In samples 8 to 13, the atomic ratio of Fe to Ti in the dielectric green sheet, which is the precursor of the observation region, is 0.01 or higher, and the atomic ratio of the additive element to Fe is 3 or less. Therefore, it is considered that Fe moved to the interfaces between the dielectric green sheet and the internal electrode patterns during firing, and after sintering in the samples 8 to 13, Fe was segregated between the dielectric layer and the internal electrode layers. In samples 8 to 13, it is considered that an Fe-containing segregated layer formed between the dielectric layer and the internal electrode layers increased the electrical barrier between the dielectric layer and the internal electrode layers, resulting in high insulation reliability.

On the other hand, in samples 14 and 15, the atomic ratio of the additive element to Fe is 3.4 or higher, resulting in a higher additive element content relative to the Fe content than in samples 8 to 13. In samples 14 and 15, the additive element content relative to the Fe content is high, and thus during the firing, Fe combines with the additive element, thereby prohibiting the sufficient amount of Fe from moving to the interfaces between the dielectric green sheet and the internal electrode patterns. As a result, the electrical barrier between the dielectric layer and the internal electrode layers was not increased sufficiently, resulting in a degraded insulation reliability.

In addition, in sample 15, the Fe²⁺ content ratio is 0.89, indicating a significant increase in the Fe²⁺ content within the dielectric layer. In an oxygen-containing environment, Fe²⁺ combines with oxygen and transforms into Fe³⁺, which is more stable. Since the dielectric layer is mainly composed of an oxide represented by the chemical formula ABO₃, excessive Fe²⁺ content in the dielectric layer causes Fe²⁺ to extract oxygen from the oxide which is the main component of the dielectric layer, thereby generating oxygen defects in the oxide of the dielectric layer. When a voltage is applied to the capacitor, the oxygen defects generated in the oxide which is the main component of the dielectric layer moves from inside the dielectric layer toward the interfaces with the internal electrode layers. This movement induces an electric field near the interfaces, thereby lowering the electrical barrier at the interfaces and increasing the leakage current. Therefore, in sample 15, it is possible that the insulation reliability has deteriorated due to an excessively high Fe²⁺ content in the dielectric layer.

Next, an insulation resistance test was performed on each of samples 8 to 15 by the same method as for samples 1 to 7, and determination was made based on the same criteria as to whether each sample was “Passing” or “Failing”.

As shown in Table 2, samples 8 to 11 and samples 14 to 15 were determined to be “Passing” in the insulation resistance test, as the measured IR values were 100 MΩ or higher. On the other hand, samples 12 and 13 were determined to be “Failing” in the insulation resistance test, as the measured IR values were less than 100 MΩ.

In samples 8 to 11, the Fe²⁺ content ratio in the dielectric layer has increased from 0.33, which is the same ratio as in Fe₃O₄, to the range of 0.64 to 0.77. This indicates that, in samples 8 to 11, the content of Fe₃O₄ in the dielectric layer has decreased compared to that in the sintered compacts as their respective precursors. Thus, in samples 8 to 11, the Fe₃O₄ content is considered to have decreased to such a level that the Fe²⁺ content ratio reached the range of 0.64 to 0.77, resulting in an improvement in DC resistance.

In samples 14 and 15, the content of the additive element having a greater ionization tendency than Fe is excessive in the dielectric green sheet. As a result, the additive element is preferentially oxidized over Fe, resulting in a reduction in the amount of Fe₃O₄ generated. This is considered to be the reason for the high insulation resistance.

For sample 12, because of the high Fe content, the sintered compact contains a large amount of Fe₃O₄. The addition of Al is considered to have inhibited the generation of Fe₃O₄ to some extent, as supported by the fact that the Fe²⁺ content ratio in sample 12 is higher than that in sample 6. Nevertheless, sample 12 contains a larger amount of Fe₃O₄ generated than samples 8 to 11, which is considered to have resulted in a decrease in the DC resistance value of sample 12 to below 100 MΩ.

For sample 13, the amount of Al added relative to the Fe content is small, and this trace amount of Al was insufficient to adequately inhibit the generation of Fe₃O₄. As a result, the DC resistance value of sample 13 is considered to have decreased to below 100 MΩ.

Samples 8 to 11, which were determined to be “Passing” in both the insulation reliability test and the insulation resistance test described above, were determined to be “Passing” in the overall determination. Samples 8 to 11, which were determined to be “Passing” in the overall determination, maintain excellent insulation reliability accomplished by the intermediate layers formed between the dielectric layer and the internal electrode layers and containing Fe at a high concentration. Additionally, with the Fe²⁺ content ratio in the dielectric layer increased to the range of 0.68 to 0.77, which is higher than 0.33, the hopping conduction of free electrons between Fe₃O₄ molecules in the dielectric layer is inhibited, thereby inhibiting a reduction in insulation resistance of the dielectric layer. In addition, with the Fe²⁺ content ratio being 0.8 or less, the generation of oxygen defects in the oxide of the dielectric layer is inhibited.

### (5) Notes

The dimensions, materials, and arrangements of the constituent elements described for the above various embodiments are not limited to those explicitly described for the embodiments, and these constituent elements can be modified to have any dimensions, materials, and arrangements within the scope of the present invention.

Constituent elements not explicitly described herein can also be added to the above-described embodiments, and it is also possible to omit some of the constituent elements described for the embodiments.

The words “first,” “second,” “third” and so on used herein are added to distinguish constituent elements but do not necessarily limit the numbers, orders, or contents of the constituent elements. The numbers added to distinguish the constituent elements should be construed in each context. The same numbers do not necessarily denote the same constituent elements among the contexts. The use of numbers to identify constituent elements does not prevent the constituent elements from performing the functions of the constituent elements identified by other numbers.

The expression of “including” a constituent element used herein does not exclude other constituent elements but rather means that other constituent elements can be further included, as long as they are consistent with the invention.

### (6) Additional Embodiments

Embodiments disclosed herein also include the following.

### Additional Embodiment 1

A capacitor comprising:
a body including a first internal electrode layer, a second internal electrode layer, a dielectric layer disposed between the first internal electrode layer and the second internal electrode layer and containing Fe²⁺ and Fe³⁺, and a first intermediate layer disposed between the first internal electrode layer and the dielectric layer and containing Fe;
a first external electrode provided on the body so as to be electrically connected to the first internal electrode layer; and
a second external electrode provided on the body so as to be electrically connected to the second internal electrode layer,
wherein in the dielectric layer, an Fe²⁺ content ratio, which represents an atomic ratio of Fe²⁺ to a total of Fe²⁺ and Fe³⁺, is from 0.4 to 0.85.

### Additional Embodiment 2

The capacitor of Additional Embodiment 1, wherein the dielectric layer contains a dielectric represented by a general formula ATiO₃ (where A is one or more elements selected from the group consisting of Ba, Sr, Ca, and Mg).

### Additional Embodiment 3

The capacitor of Additional Embodiment 1 or 2, wherein the dielectric layer contains an additive element having a greater ionization tendency than Fe.

### Additional Embodiment 4

The capacitor of Additional Embodiment 3, wherein the additive element is one or more elements selected from the group consisting of Al, Sn, and Si.

### Additional Embodiment 5

The capacitor of Additional Embodiment 4, wherein an atomic ratio of the additive element to Fe in the dielectric layer is from 0.1 to 3.

### Additional Embodiment 6

The capacitor of any one of Additional Embodiments 1 to 5, wherein a main component of the first internal electrode layer and the second internal electrode layer is Ni, Cu, or Sn.

### Additional Embodiment 7

The capacitor of any one of Additional Embodiments 1 to 6, wherein a concentration of Fe in the first intermediate layer is higher than a concentration of Fe in the dielectric layer.

### Additional Embodiment 8

The capacitor of any one of Additional Embodiments 1 to 7, wherein the concentration of Fe in the first intermediate layer is higher than a concentration of Fe in the first internal electrode layer.

### Additional Embodiment 9

The capacitor of any one of Additional Embodiments 1 to 8, wherein the body further includes a second intermediate layer disposed between the second internal electrode layer and the dielectric layer and containing Fe.

### Additional Embodiment 10

The capacitor of Additional Embodiment 9, wherein a concentration of Fe in the second intermediate layer is higher than a concentration of Fe in the dielectric layer.

### Additional Embodiment 11

The capacitor of Additional Embodiment 10, wherein the concentration of Fe in the second intermediate layer is higher than a concentration of Fe in the second internal electrode layer.

### Additional Embodiment 12

The capacitor of any one of Additional Embodiments 1 to 11, wherein the Fe²⁺ content ratio in the dielectric layer is from 0.5 to 0.75.

### Additional Embodiment 13

The capacitor of any one of Additional Embodiments 1 to 12, wherein the Fe²⁺ content ratio in the dielectric layer is from 0.55 to 0.7.

### Additional Embodiment 14

A circuit module comprising the capacitor of any one of Additional Embodiments 1 to 13.

### Additional Embodiment 15

An electronic device including the circuit module of Additional Embodiment 14.

### Additional Embodiment 16

A method of manufacturing a capacitor comprising the steps of:
preparing a compact including a dielectric green sheet and internal electrode patterns provided on a first surface and a second surface of the dielectric green sheet;
performing a first heating process in which the compact is heated in a first atmosphere with a first oxygen partial pressure; and
performing a second heating process in which the compact heated in the first heating process is heated in a second atmosphere with a second oxygen partial pressure lower than the first oxygen partial pressure,
wherein at least one of the dielectric green sheet or the internal electrode patterns contain Fe.

### Additional Embodiment 17

A method of manufacturing a capacitor comprising the steps of:
preparing a compact including a dielectric green sheet and internal electrode patterns, the dielectric green sheet containing Fe and an additive element having a greater ionization tendency than Fe, the internal electrode patterns being provided on a first surface and a second surface of the dielectric green sheet; and
performing a heating process of heating the compact.

### Additional Embodiment 18

The method of Additional Embodiment 16 or 17,
wherein the dielectric green sheet contains dielectric powder represented by a general formula ATiO₃ (where A is one or more elements selected from the group consisting of Ba, Sr, Ca, and Mg), and
wherein an atomic ratio of Fe to Ti in the dielectric green sheet is from 0.01 to 3.

What is claimed is:

1. A capacitor comprising:
a body including a first internal electrode layer, a second internal electrode layer, a dielectric layer disposed between the first internal electrode layer and the second internal electrode layer and containing Fe²⁺ and Fe³⁺, and a first intermediate layer disposed between the first internal electrode layer and the dielectric layer and containing Fe;
a first external electrode provided on the body so as to be electrically connected to the first internal electrode layer; and
a second external electrode provided on the body so as to be electrically connected to the second internal electrode layer,
wherein in the dielectric layer, an Fe²⁺ content ratio, which represents an atomic ratio of Fe²⁺ to a total of Fe²⁺ and Fe³⁺, is from 0.4 to 0.85.

2. The capacitor of claim 1, wherein the dielectric layer contains a dielectric represented by a general formula ATiO₃ (where A is one or more elements selected from the group consisting of Ba, Sr, Ca, and Mg).

3. The capacitor of claim 1, wherein the dielectric layer contains an additive element having a greater ionization tendency than Fe.

4. The capacitor of claim 3, wherein the additive element is one or more elements selected from the group consisting of Al, Sn, and Si.

5. The capacitor of claim 4, wherein an atomic ratio of the additive element to Fe in the dielectric layer is from 0.1 to 3.

6. The capacitor of claim 1, wherein a main component of the first internal electrode layer and the second internal electrode layer is Ni, Cu, or Sn.

7. The capacitor of claim 1, wherein a concentration of Fe in the first intermediate layer is higher than a concentration of Fe in the dielectric layer.

8. The capacitor of claim 7, wherein the concentration of Fe in the first intermediate layer is higher than a concentration of Fe in the first internal electrode layer.

9. The capacitor of claim 1, wherein the body further includes a second intermediate layer disposed between the second internal electrode layer and the dielectric layer and containing Fe.

10. The capacitor of claim 9, wherein a concentration of Fe in the second intermediate layer is higher than a concentration of Fe in the dielectric layer.

11. The capacitor of claim 10, wherein the concentration of Fe in the second intermediate layer is higher than a concentration of Fe in the second internal electrode layer.

12. The capacitor of claim 1, wherein the Fe²⁺ content ratio in the dielectric layer is from 0.5 to 0.75.

13. The capacitor of claim 1, wherein the Fe²⁺ content ratio in the dielectric layer is from 0.55 to 0.7.

14. A circuit module comprising the capacitor of claim 1.

15. An electronic device comprising the circuit module of claim 14.

16. A method of manufacturing a capacitor comprising the steps of:
preparing a compact including a dielectric green sheet and internal electrode patterns provided on a first surface and a second surface of the dielectric green sheet;
performing a first heating process in which the compact is heated in a first atmosphere with a first oxygen partial pressure; and
performing a second heating process in which the compact heated in the first heating process is heated in a second atmosphere with a second oxygen partial pressure lower than the first oxygen partial pressure,
wherein at least one of the dielectric green sheet or the internal electrode patterns contain Fe.

17. A method of manufacturing a capacitor comprising the steps of:
preparing a compact including a dielectric green sheet and internal electrode patterns, the dielectric green sheet containing Fe and an additive element having a greater ionization tendency than Fe, the internal electrode patterns being provided on a first surface and a second surface of the dielectric green sheet; and
performing a heating process of heating the compact.

18. The method of claim 16,
wherein the dielectric green sheet contains dielectric powder represented by a general formula ATiO₃ (where A is one or more elements selected from the group consisting of Ba, Sr, Ca, and Mg), and
wherein an atomic ratio of Fe to Ti in the dielectric green sheet is from 0.01 to 3.
